(19) United States
(12) Patent Application Publication
(10) Pub. No.: US 2011/0145729 A1
(43) Pub. Date: Jun. 16, 2011

(54) Method and system for capturing and displaying lead information

(76) Inventor: Wayne Shulman, Delray Beach, FL (US)

(21) Appl. No.: 12/653,421

(22) Filed: Dec. 14, 2009

(51) Int. Cl. G06F 17/30; G06F 3/01

(52) U.S. Cl. 715/760; 707/802; 707/E17.005; 707/E17.044

(57) ABSTRACT

The present invention generally relates to a method and system that converts event registration information into leads for exhibitors. More specifically, the present invention captures, organizes, and presents attendee registration info as leads for an exhibitor via SMS/texting of attendee info into a database and Networked retrieval of the same. An event organizer enters attendee's information into a Networked database. If an attendee is interested in an exhibitor's offerings, then attendee, using a mobile device, texts exhibitor's keyword phrase to exhibitor's SMS short code. A switching center and SMS gateway sends attendee's texts to the database. The database recognizes exhibitor's short code; keyword phrase; and the attendee's mobile device number. Modules are triggered to retrieve and extract attendee's registration info into a table corresponding to the exhibitor short code. The exhibitor is presented with attendee's registration info as lead information over a Network via a web-based GUI.

### CROSS REFERENCE TO RELATED APPLICATIONS

This patent application does not claim priority to any previously filed patent applications.

### FIELD OF THE INVENTION

The present invention generally relates to a method and system that converts event registration information into leads for exhibitors. More specifically, the present invention captures, organizes, and presents attendee registration info as leads for an exhibitor via SMS/texting of attendee info into a database and Networked retrieval of the same. An event organizer enters attendee's information into a Networked database. If an attendee is interested in an exhibitor's offerings, then attendee, using a mobile device, texts exhibitor's keyword phrase to exhibitor's SMS short code. A switching center and SMS gateway sends attendee's texts to the database. The database recognizes exhibitor's short code; keyword phrase; and the attendee's mobile device number. Modules are triggered to retrieve and extract attendee's registration info into a table corresponding to the exhibitor short code. The exhibitor is presented with attendee's registration info as lead information over a Network via a web-based GUI.

### BACKGROUND OF THE INVENTION

At an event, there are three primary participants: (i.) an event organizer, that plans and organizes the event; (ii.) exhibitors, that showcase products, services, and/or promotions at one or more event booths; and (iii.) attendees, that attend the event. Presenters may submit publications and/or make live presentations at events. Also, event sponsors; advertisers; and/or exhibitors pay the event organizer to receive prominent advertising space on an event floor.

Exhibitors at events want contact information on attendees for marketing purposes. However, an attendee, during event registration, gives information to the event manager that is sought by exhibitors. This information includes but is not limited to: attendee's name and address; spending habits; income; email-id; region of residence; company name; business phone; fax number; web site; age; sex; and/or occupation.

At business events, attendees sometimes register in advance. Event organizers mail, or an attendee may pick up on site, a badge with a barcode, magstripe, or RFID tag. Contained in that badge is attendee's contact information or such items contain a number that is then linked to a database where their contact information is stored. Each exhibitor scans the badge of an interested attendee to get his or her contact information. However, there is an expense in printing barcodes for each attendee in addition to the expense and extra work dealing with barcode scanners or such readers.

In addition, exhibitors can designate an attendee's level of interest with a list of qualifiers such as hot lead or send literature to attendee. Exhibitors may also be able to add notes or ask survey questions such as: “When will you purchase our item,” where the attendee may have a choice of two or more answers. However, with consumer and some business events, many other venues, or locals where events are held, pre registration is difficult or impossible.

Patent Publication No. 2008/0312946 filed by Valentine, et. al. concerns a location based method of registering booth attendees that includes a management system; one or more wireless systems; one or more computers; and one or more databases. A wireless system used for tracking attendee's movement about the event is an integral part of the application. The wireless system sends registration info to exhibitors based on attendee's proximity to exhibitor's booth.

Techweb Technologies, a company out of India, sells lead generation services to advertisers. The service is based on SMS technology. An advertiser asks readers interested in a product, as seen in print, to text their email-id to the advertiser's short code. With this exchange, the advertiser acquires the reader's email-id and cell phone number. The advertiser is then able to send promotional emails to the reader.

Therefore, there is a need for an improved method and system to convert attendee registration info into lead info for exhibitors using SMS/texting and a Networked database.

### SUMMARY OF THE INVENTION

Embodiments of the present invention disclose a method and system for converting attendee registration information into exhibitor leads. One embodiment of the invention includes: an event organizer securing a Networked database and SMS gateway; an attendee and an exhibitor giving their information to the event organizer to place in at least two separate tables within the database; an attendee using a mobile device to text an exhibitor's keyword phrase to exhibitor's short code; an SMS gateway converting SMSC protocols having at least attendee's mobile device number; exhibitor's keyword phrase; and exhibitor's short code to a language recognized and received by the database and sending converted protocols to the database; the database corresponding at least one row within a table having attendee's information with attendee's mobile device number and extracting that row into at least one table corresponding with exhibitor's keyword phrase and short code; and the database sending at least one table corresponding to exhibitor's keyword phrase and short code over a Network and into a GUI on a computer server.

It is an embodiment of the invention wherein an additional step includes an exhibitor sending follow up questions to attendee's mobile device and receiving attendee's answers through the same.

It is an embodiment of the invention wherein the SMS gateway converts SMSC protocols into database programming languages including but not limited to: ANSI C/ANSI C++; Delphi; Visual Basic; MS SQL/ASP.NET; MS Access/Visual Basic; MySQL/Coldfusion (CFML); HSQL/JSP (J2EE); PostgreSQL/Perl; MS SQL/Foxpro; Oracle/ASP.NET; ASP; C++; HTTP; PHP; JavaScript; MySQL; or XLM.

It is an embodiment of the invention wherein the Network database includes a private relational database that stores a collection of data on individual tables having attendee and exhibitor information accessible over a Network.

Another embodiment of the invention includes having attendee information located on a table within the database being inserted directly from that table, within the database and into an exhibitor's virtual table located at the computer server.

It is an embodiment of the invention wherein attendee information is presented in real or delayed time to an exhibitor's remote computer as a web-based GUI whenever attendee texts information to exhibitor's short code.

It is a further embodiment of the invention wherein the computer server is maintained by a third party, which allows an exhibitor to view attendee's information as a web-based GUI via a remote Networked computer.

It is an embodiment of the invention wherein the computer server is maintained by a third party, which allows an exhibitor to view attendee's information as a web-based GUI via a remote Networked computer.

It is within the scope of the present invention wherein the computer server has a GUI with at least one virtual table corresponding to exhibitor's keyword phrase and short code and is accessible to an exhibitor as a web-based application via a remote Networked computer.

It is an embodiment of the invention wherein the attendee information includes attendee's attendee's name; mobile phone number; home address; home phone number; home fax; email address; business name; business address; title; business phone number; median income; business fax; business email; age; sex; date of birth; income; or birth city.

It is another embodiment of the invention wherein the exhibitor information includes at least exhibitor's name, business address; exhibitor's keyword phrase; exhibitor's short code number; or exhibitor's follow up questions.

It is within the scope of the invention wherein the mobile device includes cellular phones; personal digital assistants; or handheld (mobile) computer devices capable of wireless communication and SMS; MMS messaging; or email messaging.

It is another embodiment of the invention wherein the event organizer includes any company, group of companies, or individuals that host or provides a space for a trade show; conference; exposition; stadium; street event; public event; or any gathering with an event organizer; concerts; bars; restaurants; public venues; private venues; or fair for which goods or services for any industry are exhibited, demonstrated, or provided.

It is another embodiment of the invention wherein the SMS gateway and the database are interfaced and housed within the same computer server.

It is an embodiment of the invention wherein the SMS gateway and the database are interfaced and housed on different computer servers.

It is an embodiment of the invention wherein an attendee gives their registration information to an event organizer via SMS or email messaging.

### BRIEF DESCRIPTION OF THE DRAWINGS

These and other features will now be described with reference to the drawings summarized below. These drawings and the associated description are provided to illustrate embodiments of the invention and not to limit the scope of the invention. Throughout the drawings, reference numbers are re-used to indicate correspondence between referenced elements.

FIG. 1 illustrates an SMS pathway for an attendee text, where the wireless message is directed to a short service message center and flows to an SMS gateway interfaced to a database having multiple tables. The database sends attendee's info to a remote server that is responsible for presenting attendee's registration info to an exhibitor as a web-based GUI.

FIG. 2 illustrates various database tables for the present invention.

### DETAILED DESCRIPTION OF THE INVENTION

Definitions

To detail the present invention, the following non-limiting terms are used.

The term “event(s)” generally refer(s) to a trade show; conference; exposition; or similar event at which goods and/or services in an industry or of a company; group of companies; or an individual are exhibited and/or demonstrated, where non-limiting examples include college fairs; auto industry trade shows, entertainment and electronic trade shows; professional sports related trade shows; and the like.

The term “attendee” generally refers to a person that provides his contact information to an event organizer before or during an event hosted or arranged by the organizer.

The term “short code” generally refers to special telephone numbers that are significantly shorter, or slightly longer, than full telephone numbers. They are used to address SMS and MMS messages from mobile or fixed phones.

The terms “keyword;” “keyword phrase;” and/or “phrase” generally refers to a unique term of letters and/or numbers that an attendee can use to communicate with the event organizer and/or exhibitor via a short code. A particular keyword is unique to a particular short code, or various keywords maybe used. However, the same keyword may be used across multiple short codes.

The term “mobile device” generally refers to any device capable of wireless communication and, more specifically, SMS or MMS servicing. This includes, but is not limited to, cellular phones; personal digital assistants; and/or handheld (mobile) computer devices.

The term “lead(s)” generally refer(s) to information on attendees sought by exhibitors at an event. Exhibitors use attendee information for future marketing purposes. Attendee personal information may include but is not limited to: attendee's name; residential address; email-id; age; sex; attendee's employer name and address; income; or job title.

The terms “switching center;” “mobile switching center;” and/or “MSC” generally refer to the primary service delivery node for GSM (Global System for Mobile communications), or simply, a computer server that sends and receives SMS messages from mobile devices as provided for by commercial wireless services.

As a non-limiting example, the MSC connects to the following elements: a home location register (HLR) for obtaining data about the SIM and mobile services ISDN number (i.e., the telephone number); a base station subsystem, which handles the radio communication with mobile phones; a UMTS terrestrial radio access network (UTRAN), which handles the radio communication mobile phones; and a visitor location register (VLR), for determining where other mobile subscribers are located.

MSC tasks include without limitation: delivering phone calls to mobile subscribers as they arrive based on information from the VLR; connecting outgoing calls to other mobile subscribers or the PSTN; delivering SMSs from subscribers to the short message service centre (SMSC) and vice versa; arranging handovers from Base Station Center to Base Station Center; or carrying out handovers from the MSC to another.

The terms “SMS/texting;” and “MMS” generally refer to short message service and multimedia messaging service respectively. Both are globally accepted wireless services that enable the transmission of alphanumeric messages between mobile subscribers and external systems such as electronic mail; paging; voice-mail systems; and/or Network databases. SMS was originally designed as part of the GSM digital mobile phone standard, but is now available on a wide range of networks, including 3G and 4G networks. MMS extends the core SMS capability, which only allows text messages of 160 characters. MMS allows messages having multimedia content to and from mobile phones.

The term “SMS gateway” generally refers to a device or service offering conversion of one SMSC protocol to another. As a non-limiting example SMS gateways convert various SMS protocols to HTTP; PHP; JavaScript; or SQL platforms. Different companies using their own proprietary protocols develop SMSCs. To connect to an SMS gateway, one may use an SMSC protocol such as SMPP and CIMD. Various modules known within the arts of SMS gateways can be set up to handle connections to various SMSCs. As stated, some SMS gateways support an HTTP/HTTPS interface, allowing mobile devices to send and receive info to SMS gateways interfaced with Networked databases. Various commercial services offer SMS gateway software and servers to achieve protocol conversion of proprietary SMS protocols.

The term “exhibitor(s)” generally refer(s)s to a person; company; or companies that present; offer; or demonstrate their wares, services, and/or goods at an event to one or more attendees to the event.

The term “event organizer,” or “organizer” generally refers to any company, group of companies, or individuals that host or provides a space for a trade show; conference; exposition; stadium; street event; public event; any gathering with an event organizer; concerts; bars; restaurants; public venues; private venues; or fair for which goods or services for any industry are exhibited or demonstrated.

The term “module” generally refers to a part of a computer program; sub-routine; procedure; definitional statement; and/or macro that performs a distinct function. Each module may be separately compiled and linked into a single executable program. The module processes may be arbitrarily redistributed to one of the other modules, combined together in a single module, or made available in, for example, a shareable dynamic link library. The modules used for the present invention are standard and well known within the art. Non-limiting example being modules at an SMS gateway used to convert an SMSC protocol called CIMD to HTTP/HTTPS; DOM; CSS; Javascript; XML; XML/Http requests; SQL request or commands; and the like.

The term “network” generally refers to an electronically connected group of computers including, but not limited to, the following: the World Wide Web/Internet; Intranet; Local Area Networks (LAN); Wide Area Networks (WAN); or Wireless Wide Area Networks (WWAN).

The term “database” generally refers to a private database accessible over a Network. The private database is relational and stores a collection of data on individual tables storing common or uncommon information. The database is operated and controlled by a private firm. A database administrator may implement and maintain the database system and establish policies and procedures pertaining to management; security; maintenance; and use of the database management system. The database of the present invention may understand programming languages including but not limited to: HTTP/HTTPS; DOM; CSS; Javascript; XML; XML/Http requests; SQL request or commands; and the like.

### General Embodiment of the Invention

From this point forward, the following words will describe a method and system that converts event registration info into lead info for exhibitors. However, these words are not a limitation on the scope of the present invention but are written to detail certain embodiments thereof.

The present invention captures, organizes, and presents event registration info for an attendee to exhibitors as leads. This is achieved by SMS/texting info into a Networked database and web-based retrieval of that information from the same. An attendee registers for an event by supplying information to a Networked database provided by an event organizer. Exhibitors are at the event showcasing wares; promotions; and the like. If an attendee is interested in an exhibitor's offerings, then attendee, using a mobile device, texts a keyword phrase selected by the exhibitor to exhibitor's SMS short code.

The attendee's text is received at a switching center and is subsequently delivered over a wireless system and/or a Network to an SMSC. The proprietary SMSC delivers attendee's text over a Network to a server having an SMS gateway and database. The SMS gateway converts and sends attendee's texts, including exhibitor's short code and/or keyword phrase, along with the attendee's mobile device number to the database. Database modules are triggered to retrieve and extract attendee's registration info into a table corresponding to the exhibitor's short code and/or keyword phrase. The resulting exhibitor table is presented to the exhibitor with attendee's registration info as lead information over a Network via a web-based GUI.

Attendee Registration for an Event & Tables

Attendees may register for an event, through an event organizer, using a variety of techniques. This may include, without limitation, transferring data from a web-based registration procedure, copying (either electronically or manually) information from a registration form that is faxed, e-mailed, provided verbally, or by the attendee sending at least one SMS message with registration info to an SMS short code selected by the event organizer.

The registration form requests information from an attendee including but not limited to: attendee's name; mobile phone number; home address; home phone number; home fax; email address; business name; business address; title; business phone number; median income; business fax; business email; age; sex; date of birth; income; birth city.

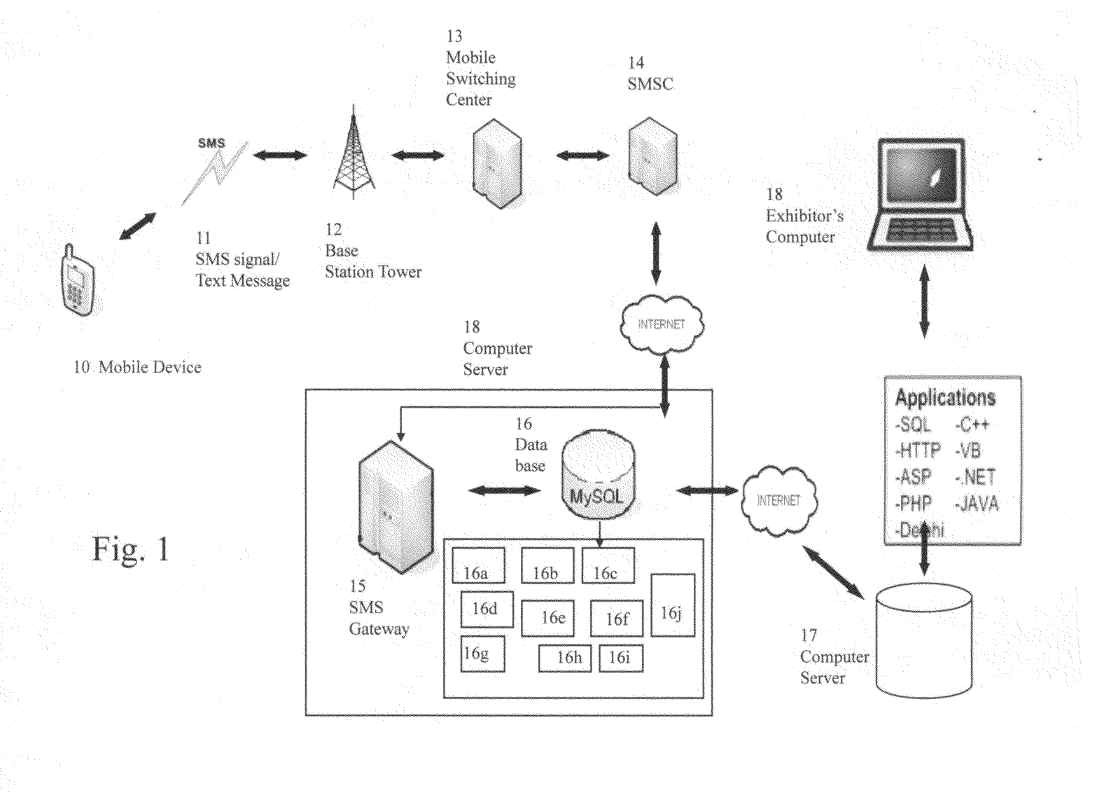

Irrespective of what technique is used for event registration, all attendee info will be placed into tables located within a database reserved by the event organizer. However, the preferred embodiment of the invention includes an attendee using SMS/texting to register for an event. From FIG. 1, an attendee uses a mobile device 10 to register for an event by sending at least one SMS/text 11 with varying information to an SMS short code reserved by the event organizer.

A non-limiting example includes an attendee, while registering for an event, being prompted by the event organizer to text their name; email; and zip code to the organizer's short code 567234. However, it is within the scope of the present invention where the event organizer may send multiple SMS requests 11 to attendee's mobile device 10 to gain such information. The organizer will place that information into a table 16d within the database 16, a general attendee table 16h. The general attendee table 16h is where attendee information is stored and includes but is not limited to: attendee's name; mobile phone number; home address; home phone number; home fax; email address; business name; business address; title; business phone number; median income; business fax; business email; age; sex; date of birth; income; or birth city.

Any other information an event organizer wants to gather on an attendee will be located in the Q_MNG table 16b and ANS_MNG table 16c. In addition, the table Q_EXH 16d allows and event organizer to ask any question they want to collect from exhibitors participating in the event.

An exhibitor at an event will register their contact info; at least one short code; and at least one keyword phrase with the organizer. The organizer will place that information into a table within the database 16, an exhibitor table 16g. An attendee at an event will see many exhibitors offering their wares; promotions; and the like. If an attendee is interested in an exhibitor's offerings, then attendee, using a mobile device 10, texts exhibitor's keyword phrase to exhibitor's SMS short code. A non-limiting example being, an attendee at a car show being enticed by an exhibitor selling new tires to text the keyword phrase TIRE to 567234.

The resulting mobile signal 11 goes through a switching center 13 and is delivered to a proprietary SMSC 14. From the SMSC 14, a text message 11 is delivered over a Network to a computer server 18 having at least one SMS gateway 15 and at least one database 16. It is an embodiment of the invention wherein the organizer secures and makes available, to both exhibitors and attendees, a computer server 18 having at least one SMS gateway 15 interfaced to at least one database 16. It is within the scope of the present invention where, GSM modems maybe attached to a server 18 having an SMS gateway 15 and database 16 either with a phone-to-pc data cable or an IP SMS Gateway connection, non-limiting examples being CIMD2; UCP; or SMPP to send messages directly to the SMSC 14 of the GSM Service provider.

However, it is a preferred embodiment of the invention where the SMS gateway 15 converts an SMS protocol to an HTTP/SQL platform to send/receive information to and from the database 16. For clarity, embodiments of the invention include send/receive modules at the database 16; the SMS gateway 15; and various computer servers, where the database 16 is capable of understanding HTTP or PHP protocols combined with SQL commands from the SMS gateway 15 and various computer servers over a Network. The complexity involved is hidden from both the attendee and exhibitor who, in fact, requires no knowledge of SQL; PHP; HTTP/HTTPS; MSCs; or SMS gateways in order to use the invention.

Attendee texts are converted to HTTP and SQL commands at the SMS Gateway 15. At the SMS gateway 15, the resulting HTTP and SQL commands embed at least the exhibitor's short code; exhibitor's keyword phrase; and the attendee's mobile device number. The SMS gateway 15 presents all data to the database 16.

The Database

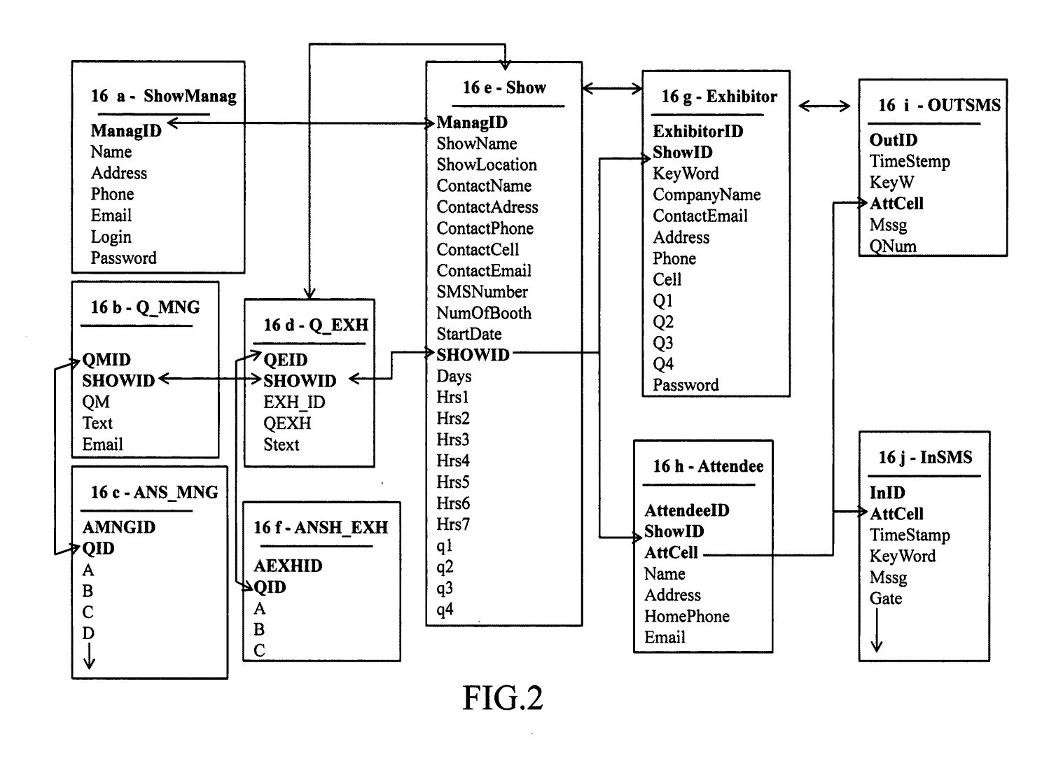

Based on the attendee's mobile device 10 number (FIG. 1), the database locates the attendee's registration info from the general attendee table 16h within the database 16. Once identified, further database modules copy the identified row into exhibitor's table 16g, where attendee's info is then sent over a Network to a computer server 17 (FIG. 2), which then allows an exhibitor to view attendee's registration info via an internet-based GUI on exhibitor's computer 18.

Attendee's registration info 16h may be copied into an exhibitor table 16g within the database 16 via well-known merge; copy; an/or insertion routines in the database arts. It is an embodiment of the invention wherein attendee information in the attendee table 16h is inserted directly from the attendee table 16h located within the database and into the exhibitor's virtual table located at the computer server 17. The exhibitor can subsequently use such data for marketing purposes.

Although the invention describes using an SMS gateway 15 to convert various SMS protocols to HTTP; PHP; JavaScript; and/or SQL platforms and at least one database 16 that can recognize the same, it is within the scope of the present invention where the combined platforms are just one of many computer languages that can be used. Other computer languages may include without limitation: MS SQL/ASP.NET; MS Access/Visual Basic; MySQL/Coldfusion (CFML); HSQL/JSP (J2EE); PostgreSQL/Perl; MS SQL/Foxpro; Oracle/ASP.NET; ASP; C++; or Delphi.

The database 16 of the present invention includes a relational database that stores a collection of data on individual tables 16a-j. The private database 16 is associated with at least one send/receive module that understands structured language commands from an SMS gateway 15 or HTTP or PHP commands from a remote computer server. Simply, the database 16 send/receive module is capable of reading and understanding the structured language commands in use, e.g. SQL, at the SMS gateway/database/remote computer server interface. A database administrator and/or one or more application developers maintain the private database, which is accessible over a Network and is kept by a private firm, non-limiting examples being MySQL, Interbase/Firebird, PSQL, IBM, Microsoft/Sybase, Oracle, and the like.

It is well known within the arts that tables 16a-j can be readily created in an SQL database using the CREATE TABLE function. From FIG. 2, the database of the present invention has at least one table 16a having information that qualifies an event organizer. This table 16a keeps data about companies that organize and manage events, where an event organizer may organize and manage many events. This table 16a may include without limitation: a management i.d. number for the organizer; the name of the organizer; an address; phone number; email; login i.d.; or password for accessing the database.

The database of the present invention also holds at least one table 16e having information qualifying an event or show. This table 16e includes but is not limited to a show/event i.d. number; a management/organizer i.d.; the name of the event; the location of the event; a contact name for the event; a contact address fort he event; a contact phone number for the event; a contact cell phone number for the event; a contact e-mail for the event; an SMS short code for the event; the number of booths/displays anticipated for the event; event start date; and various other qualifiers.

This database contains at least one table 16h having all attendee info obtained and entered into the database 16 by the organizer during attendee registration. For each cell in each row of the general table 16h, qualifying info for attendee is stored, where all qualifying data in a row are linked to attendee's mobile device 10 number located in the same row of the general table 16h. This ensures rapid identification of attendee's info for future extraction into an exhibitor's table within the database 16.

The database 16 also contains at least one exhibitor table 16g, where the table holds qualifying information on an exhibitor. Such information may include but is not limited to: an exhibitor i.d. given by the organizer to an exhibitor before or during an event; an event i.d.; the exhibitor company name; exhibitor contact email; exhibitor address; exhibitor phone number; exhibitor short code; exhibitor keyword phrase; and various follow up questions for attendees that text exhibitor's keyword phrase to exhibitor's short code.

Each exhibitor table 16g is linked to exhibitor's short code and/or keyword phrase. When inserting attendee information into an exhibitor's table 16g, database modules identify the exhibitor table 16g by the exhibitor short code and keyword phrase. Upon receiving attendee's mobile device 10 number; exhibitor's short code; and/or keyword phrase from the SMS gateway 15, database modules place attendee info into specific cells in specific rows within that table having the corresponding exhibitor short code and keyword phrase.

The database 16 also contains at least two tables for recording initial and/or outgoing SMS/texts or converted messages received from the SMS gateway 15 or HTTP/SQL requests from computers over a network. These tables 16i,j may contain information including but not limited to: incoming attendee cell phone number; attendee time stamp; exhibitor i.d.; show i.d.; and incoming and outgoing messages, where such messages can be directed to the SMS gateway or over a Network to a computer server having an Internet-based GUI.

SQL Statements

In a preferred embodiment, wireless texts from the attendee's mobile device are converted at the SMS gateway into queries or statements in an SQL code that is supported by the MySQL-PHP platform. MySQL is a multithreaded, multi-user SQL database management system (DBMS). The basic program runs as a server providing multi-user access to a number of databases. MySQL is commonly used in web applications and acts as the database component of the LAMP; MAMP; and WAMP platforms; non-limiting example being Linux; Mac; Windows; Apache; MySQL-PHP; Perl; and Python platforms. A standard SQL statement usually takes the form: “SELECT <string> FROM <string> WHERE <string> GROUP BY <string> HAVING <string> ORDER BY <string>.” More information on SQL can be found at: http://dev.mysql.com/doc/.

However, one of ordinary skill in the art would recognize that other platform sources may be used at the SMS gateway/database interface. Other platform sources may include, but are not limited to: Oracle; IBM; ANSI; or the like. Any programming language that works with the MySQL platform may be used with the present invention. The programming languages may include but are not limited to: ANSI C/ANSI C++; Delphi; or Visual Basic.

The following is a non-limiting example of an SQL segment generated at the database that places attendee registration info into a general table within the database during an SMS registration process. This command is typically generated after such information is received from the SMS/gateway by the database. However, such a command could be generated on the SMS gateway side of the interface.

strSQL=“insert into Attendee (AttCell, ShowID) values (‘“& PH &’”, “& SHOWnum &”)” objSMS.Execute(strSQL).

When attendee uses his mobile device to text exhibitor's keyword phrase to exhibitor's short code, resulting SQL statements at the database prompt database modules to extract attendee's information form the general table into the exhibitor's table within the database. In SQL language, an INSERT operation allows a row from at least one general table having attendee's information to be placed into a new row within at least one exhibitor table in the database.

SQL modules within the database are designed to locate attendee's information within the general table by attendee's mobile device number and insert that information into the exhibitor's table. Database modules are able to locate the exhibitor's table and place attendee's information into the same by linking exhibitor's short code and keyword phrase, as communicated via the SMS gateway, to exhibitor's table. This becomes important for grouping relevant information into a single table for an exhibitor, rather than requiring the search engine to repeatedly parse the entire database to assemble the requested data, thus saving time.

The following is a non-limiting example of an SQL segment that places attendee registration info into an exhibitor's table within the database when attendee texts exhibitor's keyword phrase to exhibitor's short code.

strSQLIN=“INSERT INTO InSMS(AttCell,KeyWord,MSSG,Gate,Qnum) VALUES(‘“& PH &’”, ‘“& KEYW &’”, ‘“& SMS &’”, “& GT &”, ‘“& QnumO&’”)” objSMS.Execute(strSQLIN).

Computer Server and the Exhibitor's GUI

When attendee's information is inserted into the exhibitor's table located at the database, send/receive modules within the database export all information within exhibitor's table over a Network to a remote computer server. Computer servers are well known within the arts. However, a computer server should at least have a central processing unit; a main memory for storing programs or data; and a fixed or hard disk drive unit; which are all coupled by a data bus.

The computer server is outfitted with send/receive modules, where each module is capable of reading and understanding the structured query language in use, e.g. SQL. However, one of ordinary skill in the art recognizes that all relevant modules could be stored and executed at an end computer, thus eliminating the need for a server computer. The server is connected to a Network and distributes data to remote Networked computers.

Simply, the exhibitor receives and views all attendee registration info within web-based GUIs generated at the computer server. The exhibitor accesses the GUIs by logging into a Network application and authenticating basic exhibitor identification. When authenticated, the exhibitor receives real time updates of attendee leads from the computer server whenever an attendee texts exhibitor's keyword phrase to exhibitor' short code.

The web application also allows an exhibitor to query an attendee with various follow up questions. There are fields within exhibitor's GUI which are populated with questions posed to the attendee and pertains to exhibitor's interests. An exhibitor selects which questions to ask the attendee. The queries are sent to the computer server via PHP or HTTP/SQL commands to the database and are converted to SMSC protocols at the SMS gateway.

Exhibitor's queries follow a reverse signal path to attendee's mobile device. Attendee receives exhibitor's queries as SMS or MMS messages. If attendee answers a query, the signal follows the signal path to the database and is inserted into the exhibitor's table within the database and is ultimately returned to exhibitor's GUI via the Networked computer server. Follow up questions allow exhibitors to better gauge an attendee's level of interest in exhibitor's wares or services.

The following non-limiting example is of an SQL statement that extracts attendee information from an exhibitor's table within the database into virtual tables located at the computer server. Tables at the computer server are created and reserved for each exhibitor reporting at least their keyword phrase and short code to the organizer before or during an event.

Private Function buildHTML_Database( )
Dim sValue, s
Dim rstSchema
if m_sDBName <> ″″ then
s = Replace(STR_DB_TITLE, ″%1″, m_sDBName)
else
s = Replace(STR_DB_TITLE, ″%1″, STR_DATABASE)
end if
sValue = _{—}
″<p><span class=″″ute_headline″″>″ & s & ″</span></p>″ & vbCrLf &
_{—}
″<table width=″″100%″″><tr>″ & vbCrLf & _{—}
″<td class=″″ute_navigation″″>″ & vbCrLf & _{—}
″<ul class=″″ute_table_list″″>″ & vbCrLf
Set rstSchema = m_DB.OpenSchema(adSchemaTables)
Do Until rstSchema.EOF
if UCase(rstSchema(″TABLE_TYPE″)) = “TABLE” then
s = Request.QueryString
s = getLink(m_sUTEScript, s, sParamTable,
rstSchema(″TABLE_NAME″))
s = getLink(m_sUTEScript, s, sParamMode, MD_TABLE)
sValue = sValue & ″<li><a href=″″″ & s & ″″″>″ &
rstSchema(″TABLE_NAME″) & ″</a>″ & vbCrLf
end if
rstSchema.MoveNext
Loop
rstSchema.Close
Set rstSchema = Nothing
sValue = sValue & _{—}
″</ul>″ & vbCrLf & _{—}
″</td></tr></table>″ & vbCrLf & _{—}
getPoweredBy
buildHTML_Database = sValue
End Function
%>

Exhibitor's GUI

It is within the scope of the present invention where exhibitor tables located at the computer server are sent to virtual web-based exhibitor tables on at least one computer over a Network. The computer 18 hardware may include a personal computer, a workstation, a minicomputer, a mainframe, a supercomputer, or a web or computer server.

The computer 18 should have a basic operating system such as MS Windows; Linux; Mac OS; and the like. The program may reside on, or in, a hard disk or the memory of a user's computer or may be accessible from a remote server over a Network. The program may run inside Microsoft Internet Explorer; Firefox; Netscape; Opera; Safari; or any compatible web browser, where the web browser is capable of rendering DOM; CSS; Javascript; XML; XMLHttp requests; or the like. The computer may be a desktop, server, portable, hand-held, set-top, or any other desired configuration. The computer typically receives a number of inputs and outputs for communicating information externally. Non-limiting examples of inputs and outputs may include: a keyboard, a mouse, a trackball, a joystick, a touchpad, and/or a microphone, a CRT monitor, and/or an LCD display panel.

A computer server 17, via the PHP and JavaScript platforms, presents graphical user interfaces, GUIs, to the exhibitor's computer 18 as an Internet based web application. It is an embodiment of the present invention wherein the computer server 17 is maintained by a third party that is not the exhibitor, organizer, or attendee. It is well known within the arts that PHP is a scripting language that produces dynamic web pages with stand-alone graphical applications. With the present invention, the use of PHP may include without limitation: the authentication of exhibitor's account, SMS short code, or keyword phrase; interpreting and displaying error messages to exhibitors; with programming loops and conditionals such as IF statements; WHILE statements; and/or FOR/EACH statements.

The following is a non-limiting example of HTTP/SQL segments that give an exhibitor real time or time delayed updates. Attendee registration info flows over a Network and to a web-based GUI having a virtual table to display the same.

| | |
|---|---|
| ′ Name: | getSQLStatement |

| | |
|---|---|
| ″ | ================== |

″
″ Returns SQL Statement to select/delete specific record. The statement is
″ compiled by the hidden form ″ident″ fields.
″
″ Parameter:

| | | |
|---|---|---|
| ″ | sCmd | ″select *″ or ″delete″ |

″
″ return value:

| | |
|---|---|
| ″ | string |

″
″--------------------------------------------------------------------------
Private Function getSQLStatement ( sCmd )
Dim i
Dim bFirst
Dim sSQL, sField, nType, sValue
Dim curField
i = 1
bFirst = True
sSQL = sCmd & ″ FROM ″ & m_sTable
while Request.Form(sFormUTEFieldPrefix & sFormIdentField & CStr(i)) <> ″″
sField = Request.Form(sFormUTEFieldPrefix & sFormIdentField & CStr(i))
nType = CInt(Request.Form(sFormUTEFieldPrefix & sFormIdentType &
CStr(i)))
sValue = Request.Form(sFormUTEFieldPrefix & sFormIdentValue & CStr(i))
Set curField = m_RS(sField)
sSQL = sSQL & AddWhere (sField, nType, sValue, ″=″, ″AND″, bFirst)
bFirst = False
i = i + 1
wend
getSQLStatement = sSQL
End Function
″--------------------------------------------------------------------------

| | |
|---|---|
| ″ Name: | IsErrorField |

″============
″
″ Is this an Error Field ?
″
″ Parameter:

| | |
|---|---|
| ″sName | name of field to be checked |

″
″return value:
″boolean
″
″--------------------------------------------------------------------------
Private Function IsErrorField ( sName )
Dim i, bReturn
bReturn = False
for i = 1 to UBound(m_ErrorField)
if m_ErrorField(i) = sName then bReturn = True
next
IsErrorField = bReturn
End Function
″--------------------------------------------------------------------------

| | |
|---|---|
| ″Name: | GetErrorNumber |

″==============
″
″ Returns the Error Description
″
″Parameter:

| | |
|---|---|
| ″sName | name of field the err descr. should be returned |

″
″ return value:
″string
″
″--------------------------------------------------------------------------
Private Function GetErrorDescription ( sName )
Dim i, sReturn
sReturn = ″″
for i = 1 to UBound(m_ErrorField)
if m_ErrorField(i) = sName then sReturn = sReturn & m_ErrorMessage(i) &
″<br>″
next
′ cut traling <br>
if sReturn <> ″″ then sReturn = Left(sReturn, Len(sReturn)−4)
GetErrorDescription = sReturn
End Function
″--------------------------------------------------------------------------

| | |
|---|---|
| ″Name: | PutError |

″========
″
″Put Error into Error Management
″
″Parameter:

| | |
|---|---|
| ″errField | name of field that returns an error |

| | |
|---|---|
| ″errNumber | error number |
| ″errMessage | error description |

″
″return value:
″none
″
″--------------------------------------------------------------------------
Private Sub PutError ( errField )
Dim e
Dim nError
′ the errors collections of the connection object contains all occured errors
For Each e In m_DB.Errors
nError = UBound(m_ErrorField) + 1
Redim Preserve m_ErrorField(nError)
m_ErrorField(nError) = errField
Redim Preserve m_ErrorMessage(nError)
m_ErrorMessage(nError) = e.Description
Next
Err.Clear
m_DB.Errors.Clear
End Sub
″--------------------------------------------------------------------------

| | |
|---|---|
| ″Name: | InsertFieldForm |

″===============
″
″Return HTML code for a single field (incl, heading, form element and
definitions
″
″Parameter:

| | |
|---|---|
| ″field | field object |

| | |
|---|---|
| ″bPrimaryKey | this is a primary key field |

″
″return value:

| | |
|---|---|
| ″string | HTML code″ |

″--------------------------------------------------------------------------
Private Function InsertFieldForm ( field, bPrimaryKey )
Dim sReturn, sValue
Dim sStyle, sStyleForm
Dim nSize, nMaxLength
Dim nMemoCols, nMemoRows
Dim sChecked
sStyle = ″ute_header″
if bPrimaryKey then sStyle = sStyle & ″_pk″
sStyleForm = ″ute_form_value″
if IsErrorField (field.name) then sStyleForm = ″ute_form_error”
′ field value
if m_bSubmitted then
if bPrimaryKey then
if IsNull(field.value) then
sValue = ″″
else
select case field.type
case else
sValue = CStr(field.value)
end select
end if
else
sValue = Trim(Request.Form(field.name))
end if
else
if IsNull(field.value) then
sValue = ″″
else
select case field.type
case else
sValue = CStr(field.value)
end select
end if
end if
′ html endcode field value
sValue = Server.HTMLEncode(sValue)
sReturn = _{—}
″<tr>″ & _{—}
″<td class=″″″ & sStyle & ″″″>″ & field.name & ″</td>″ & _{—}
″<td class=″″″ & sStyleForm & ″″″>″
if (NotAttrib(field.Attributes, adFldUpdatable) and NotAttrib(field.Attributes,
adFldUnknownUpdatable)) or_{—}
((NotAttrib(field.Attributes, adFldUpdatable) and bPrimaryKey)) or _{—}
(m_nFormMode = MD_DELETE) then
′ this field is not editable
if IsExcluded(field.type) then
′ this field is not editable by ute
sReturn = sReturn & _{—}
″<img src=″″″ & m_sIMAGEDir & ″exclude.gif″″ border=″″0″″ alt=″″″ &
STR_NON_VIEW & ″″″ ″ & _{—}
″width=″″16″″height=″″16″″>″
else
′ display field value
sReturn = sReturn & sValue
end if
else
′ this field is editable
select case field.type
′ VARCHAR
case adBSTR, adVariant, adChar, adVarChar, adWChar, adVarWChar
nMaxLength = field.DefinedSize
if nMaxLength > DEF_MAX_INPUT_LENGTH then
nSize = DEF_MAX_INPUT_LENGTH
else
nSize = nMaxLength
end if
′ MEMO
case adLongVarChar, adLongVarWChar
nMemoCols = DEF_MEMO_COLS
nMemoRows = DEF_MEMO_ROW
′ ELSE
case else
nMaxLength = field. Precision
if nMaxLength > DEF_MAX_INPUT_LENGTH then
nSize = DEF_MAX_INPUT_LENGTH
else
nSize = nMaxLength
end if
end select
if IsExcluded(field.type) then
sReturn = sReturn & _{—}
″<img src=″″″ & m_sIMAGEDir & ″exclude.gif″″ border=″″0″″ alt=″″″ &
STR_NON_VIEW & ″″″ ″ & _{—}
″width=″″16″″ height=″″16″″>″
else
if (field.type = adLongVarChar) or (field.type = adLongVarWChar) then
′ MEMO −> TEXTAREA
sReturn = sReturn & ″<textarea name= ″″″ & field.name & ″″″ cols=″ &
CStr(nMemoCols) & _{—}
″ rows=″ & CStr(nMemoRows) & ″>″ & sValue & ″</textarea>″
elseif (field.type = adBoolean) then
′ −> CHECKBOX
sChecked = ″″
if CBool(field.value) then sChecked = ″ checked″
sReturn = sReturn & ″<input type=″″checkbox″″ name=″″″ & field.name & ″″″″
& sChecked & ″>″
else
′ −> INPUT
sReturn = sReturn & ″<input type=″″text″″ name=″″″ & field.name & ″″″
maxlength=″ & _{—}
CStr(nMaxLength) & ″ size=″ & CStr(nSize) & ″ value=″″″ & sValue & ″″″>″
end if
′ put error message into form
if IsErrorField(field.name) then
sReturn = sReturn & ″&nbsp;″ & GetErrorDescription(field.name)
end if
end if
end if
sReturn = sReturn & ″</td>″ & vbCrLf
if m_bViewDefinitions then
sReturn = sReturn & _{—}
″<td class=″″ute_form_def″″>″ & GetTypeString(field.type) & ″</td>″ & _{—}
″<td class=″″ute_form_def″″>″ & GetAttributesString(field.attributes) & ″</td>″
end if
sReturn = sReturn & ″</tr>″ & vbCrLf
InsertFieldForm = sReturn
End Function

Registering for an Event Via Email

It is an embodiment of the invention where an attendee may register for an event via email. An attendee may be prompted by an organizer to email their registration info to an email account secured by the organizer. To email such information, an attendee may use a remote computer connected to a Network or a mobile device connected wirelessly to the same. The registration email sent by either the remote computer or mobile device will go over a Network and to an email computer server, non limiting examples being email servers maintained by Yahoo®, Google®, AOL®, and the like. From the email computer server, attendee information will be placed into the attendee table located at the database via well-known SMTPs accompanied by SQL/HTTP or PHP commands.

The foregoing words describe one embodiment of a method and system that converts event registration information into leads for exhibitors. However, these words are not a limitation on the scope of the present invention, but are written to detail certain embodiments thereof. It should be understood that changes may be made by one of ordinary skill in the art to the invention without departing from the scope of the invention, thus, the scope of the present invention is defined solely by the following claims.

What is claimed is:

1. A method and system for converting attendee registration information into exhibitor leads comprising the steps of:
a.) an event organizer securing a Networked database and SMS gateway;
b.) an attendee and an exhibitor giving their information to the event organizer to place in at least two separate tables within the database of step a.);
c.) an attendee using a mobile device to text an exhibitor's keyword phrase to exhibitor's short code;
d.) an SMS gateway converting SMSC protocols having at least attendee's mobile device number; exhibitor's keyword phrase; or exhibitor's short code to a language recognized and received by the database of step a.) and sending converted protocols to said database;
e.) the database of step d.) corresponding at least one row within a table having attendee's information from step b.) with attendee's mobile device number of step d.) and extracting said row into at least one table of step b.) corresponding with exhibitor's keyword phrase and short code, both of step d.); and
f.) the database of step e.) sending at least one table corresponding to exhibitor's keyword phrase and short code of step e.) over a Network and into a GUI on a computer server.

2. The method of claim 1, comprising the additional step of an exhibitor sending follow up questions to attendee's mobile device and receiving attendee's answers through the same.

3. The method of claim 1, wherein the SMS gateway converts SMSC protocols into database programming languages including ANSI C/ANSI C++; Delphi; Visual Basic; MS SQL/ASP.NET; MS Access/Visual Basic; MySQL/Coldfusion (CFML); HSQL/JSP (J2EE); PostgreSQL/Perl; MS SQL/Foxpro; Oracle/ASP.NET; ASP; C++; HTTP; PHP; JavaScript; MySQL; or XLM.

4. The method of claim 1, wherein the Network database includes a private relational database that stores a collection of data on individual tables having at least attendee and exhibitor information accessible over a Network.

5. The method of claim 4, wherein attendee information located on a table within the database is inserted directly from said table within the database and into an exhibitor's virtual table located at the computer server.

6. The method of claim 1, wherein attendee information is presented in real time or time delayed to an exhibitor's remote computer as a web-based GUI whenever attendee texts information to exhibitor's short code.

7. The method of claim 1, wherein the computer server is maintained by a third party, which allows an exhibitor to view attendee's information as a web-based GUI via a remote Networked computer.

8. The method of claim 1, wherein the computer server has a GUI with at least one virtual table corresponding to exhibitor's keyword phrase and short code of step f.) and is accessible to an exhibitor as a web-based application via a remote Networked computer.

9. The method of claim 1, wherein the attendee information includes attendee's name; mobile phone number; home address; home phone number; home fax; email address; business name; business address; title; business phone number; median income; business fax; business email; age; sex; date of birth; income; or birth city.

10. The method of claim 1, wherein the exhibitor information includes at least exhibitor's name, business address; exhibitor's keyword phrase; exhibitor's short code number; or exhibitor's follow up questions.

11. The method of claim 1, wherein the mobile device includes cellular phones; personal digital assistants; or handheld (mobile) computer devices capable of wireless communication and SMS; MMS; or email messaging.

12. The method of claim 1, wherein the event organizer includes any company, group of companies, or individuals that host or provides a space for a trade show; conference; exposition; stadium; street event; public event; or any gathering with an event organizer; concerts; bars; restaurants; public venues; private venues; or fair for which goods, or services, for any industry are exhibited, demonstrated, or provided.

13. The method of claim 1, wherein the SMS gateway and the database are interfaced and housed within the same computer server.

14. The method of claim 1, wherein the SMS gateway and the database are interfaced and housed on different computer servers.

15. The method of claim 1, wherein an attendee gives their registration information to an event organizer via SMS or email messaging.
